(19) United States
(12) Patent Application Publication
(10) Pub. No.: US 2003/0047558 A1
(43) Pub. Date: Mar. 13, 2003

(54) Device for heating metallic items

(76) Inventor: Steffen Niklaus, Simmerath (DE)

Correspondence Address: Selitto Behr & Kim, 203 Main Street, Metuchen, NJ, 08840, US

(21) Appl. No.: 10/221,607

(22) PCT Filed: Mar. 7, 2001
(86) PCT No.: PCT/DE01/00860

(30) Foreign Application Priority Data
Mar. 13, 2000 (DE) 100 11 367.2

(51) Int. Cl. H05B 6/36; H05B 6/78

(52) U.S. Cl. 219/673; 219/701

(57) ABSTRACT

In a device for longitudinal field heating of metallic stock, a coil (21) having two coil halves (9, 10) is provided, through which the stock is to be guided. In this case, each coil half (9, 10) includes one or more turn halves (2, 3; 14, 15; 16, 17), which are arranged one behind the other in the transport direction of the stock, and connecting elements (7; 18). Each two turn halves (2, 3; 14, 15; 16, 17) assigned to one another form one complete turn (1), the ends of these turn halves (2, 3; 14, 15; 16, 17) ending at a slight distance to one another and each turn half end being connected in an electrically conductive way to a connecting element (7; 18). The respective connecting elements (7; 18) connected to neighboring ends of two turn halves (2, 3; 14, 15; 16, 17) form a pair insulated in relation to one another by solid insulators. For simple introduction and removal of the stock, the coil halves (9, 10) may be pulled apart transverse to the transport direction to form two introduction passages. The heating appearance of a coil (21) of this type is extensively congruent with the heating of an encompassing longitudinal field coil.

### DESCRIPTION

The present invention relates to a device for heating metallic stock having a coil, which generates a longitudinal field and is to be opened, through which the stock is to be guided and which is constructed from turn halves and electrically conductive connecting elements, both ends of each turn half being positioned opposite one another, each two turn halves forming one complete turn, the ends of the turn halves forming a complete turn standing at a slight distance to one another, each end of a turn half being connected to a connecting element in an electrically conductive way, and the respective connecting elements connected to neighboring ends of two turn halves forming a pair, having current flowing through them in opposing directions, and being insulated in relation to one another.

A device for heating metallic strips is known, from U.S. Pat. No. 5,837,976, in which, in the transport direction of the stock, a two-turn coil is constructed from two upper turn halves and two lower turn halves, each turn half having two turn half ends. In this case, the upper turn halves are connected to one another into one piece by a circuit board via both first turn half ends, which lie one behind the other in the transport direction. The same is true for the two lower turn halves. The circuit board connecting the upper turn halves and the circuit board connecting the lower turn halves are arranged parallel to one another while maintaining a first gap. Furthermore, both second turn half ends of each turn are connected via circuit boards, which are arranged parallel to one another and delimit a second gap, to a power supply, provided separately for each turn. If a strip is now to be heated, it may be introduced into the coil via the laterally positioned first gap. If the strip to be treated is too thick for this purpose, it is possible to fold the coil halves apart somewhat on one side, i.e., like a beak, so that the first gap becomes wider and the second gap essentially maintains its shape. After the introduction of the strip, the coil halves are brought back into their original position, i.e., the width of the first gap is reduced again. A disadvantage of this construction is the excessive mechanical strain of the coil. A further disadvantage of this embodiment is that each coil always comprises only two turns. If a longer strip region is to be treated simultaneously, multiple devices of this type must be arranged one behind the other. The devices must be positioned in a complicated way, so that the first gap runs continuously without offset and the strip may be introduced and removed without problems. In addition, the arrangement of multiple devices one behind the other requires a more complicated power supply, since each coil is connected separately. Furthermore, it is disadvantageous that both gaps are positioned laterally on the coils. A distortion of the longitudinal field, and therefore uncontrolled heating of the edge of the strip, exists in the edge region of the coil due to the relatively wide gap, and this is precisely in the sensitive strip edge region, where the change of direction of the induced current occurs, and optimum field guiding is decisive for heating and therefore for the quality of the strip. Even slight temperature oscillations may lead to corrugation.

The object of the present invention is to provide a device for heating metallic strips of the type initially described which, with a simple construction, allows simple introduction of metallic stock having different shapes into a coil for uniform longitudinal field heating of the stock.

It is correspondingly suggested according to the present invention that the device be designed in such a way that the connecting elements of each pair are insulated relative to one another by at least one solid insulator and the turn halves of each turn and the connecting elements of each pair of connecting elements may be pulled apart from one another transverse to the transport direction of the stock to form two introduction passages for the metallic stock.

The gap between the connecting elements is partially or completely filled up by an insulator and the non-conductive region is reduced to a minimum, since the connecting elements may be positioned very near one another. A non-conductive region in a longitudinal field coil always produces distortion of the longitudinal field, which may lead to temperature oscillations. Because in this case there is only a very narrow non-conductive region, the heating appearance produced is nearly that of an encompassing longitudinal field coil. Slight temperature oscillations do not have a negative effect due to the central arrangement of the solid insulators over slabs or strips to be heated. The device may be opened to introduce the stock while forming two introduction passages. It may be pulled apart as far as desired in this way and allows simple introduction and removal of the stock. Due to its simple construction, the device is adjustable to any shape of the stock, however complex.

Furthermore, according to the present invention, the coils may be constructed from two coil halves, each having one turn half and connecting elements connected thereto. This form of the device is particularly usable for applications in the high-frequency range.

Furthermore, according to the present invention, the coil may be constructed from two coil halves, each having two or more turn halves lying one behind the other in the transport direction, connected in series to one another via the connecting elements. In this way, because multiple turn halves may be connected to one another in an electrically conductive way via connecting elements, the length of the device may be varied almost arbitrarily and therefore optimally adjusted for the heating procedure.

Furthermore, according to the present invention, the coil halves may be implemented in one piece. Through an implementation of this type, the device may be disassembled into two main components. These are easy to handle. The opening and closing of a device of this type is automatable, since care no longer has to be taken to fit individual turn halves and connecting elements exactly to one another.

Furthermore, according to the present invention, the connecting elements may be implemented as plate-shaped. Connecting elements of this type are simple to produce and, when arranged in pairs, delimit a non-conductive region of constant width.

Furthermore, it may be advantageous to arrange the main surfaces of the plate-shaped connecting elements parallel or perpendicular to the longitudinal field of the coil. In the standard embodiment, the main surfaces of the connecting elements are perpendicular to the longitudinal field of the coil. In devices for heating strip-shaped or slab-shaped stock, this corresponds to an arrangement perpendicular to the main surfaces of the stock. This arrangement guarantees a stable device, in which the coil halves, which are separated by an insulator, are pressed onto one another. However, it may also be advantageous to arrange the connecting elements parallel to the longitudinal field. This arrangement saves space in the height.

It may also be advantageous to arrange the coil halves, including the connecting elements, offset transverse to the transport direction in such a way that the connecting elements of one coil half, arranged with their main surfaces parallel to the longitudinal field, at least partially overlap with the connecting elements of the other coil half, arranged in the same way. As long as a part of the two circuit boards assigned to one another still overlap, no interfering coil opening arises and the device is functional. Through an offset of this type, it is possible, for example, to treat strips having differing widths using only one device. An arrangement of the main surfaces of the connecting elements parallel to the longitudinal field corresponds, in devices for heating strip-shaped or slab-shaped stock, to an arrangement parallel to the main surfaces of the product.

It may also be advantageous to insulate the connecting elements assigned to one another in relation to one another by a plastic plate. Insulation plates may be produced easily and cost-effectively. In addition, they have a long service life due to the low strain in the device.

Furthermore, it may be advantageous to insulate the connecting elements assigned to one another by insulation films. By using thin insulation films, the distance between two connecting plates of a pair of connecting plates may be minimized and in this way the implementation of the longitudinal field may be optimized.

Furthermore, according to the present invention, the coils may be provided with yokes. The yokes are used as magnetic return paths of the electromagnetic field. By using these magnetic conductors, the performance factor of such a device may be increased and the electromagnetic leakage field in the outer region of the coil may be reduced to a minimum.

It may also be advantageous to arrange a protective gas tunnel, through which the stock is to be guided, inside the coil in the transport direction of the stock. During inductive strip heating, strips are often annealed under a protective gas atmosphere. A protective gas tunnel may easily be introduced into the coil via the wide introduction passage in this case.

Furthermore, it may be advantageous to produce the coils from copper. Copper is the preferred material due to its outstanding conduction characteristic.

It may also be advantageous to provide one or two inverters having one individual compensation module, one joint compensation module, or two separate compensation modules for power supply of the coil halves. A further embodiment may provide an inverter on one end of the coil and a flexible connection on the other end. The connection may also be produced by solid connection of two connecting elements in place of a flexible connection. Depending on the requirements, the coil may be adjusted optimally to the heating and the energy source by combining inverter(s), flexible connections, and solid connections. If two inverters are used, the current direction and in-phase control must be considered. There may be no time offset between the amplitudes, since otherwise a non-uniform longitudinal field arises.

Furthermore, according to the present invention, the frequencies and coil currents of both coil halves are identical. In this way, a uniform longitudinal field heating of the stock is achieved. If two inverters are used, they are to be synchronized for this purpose.

Furthermore, it may be advantageous to design the frequency as variably adjustable. The frequency conforms to the geometry of the stock and the material used. For the present device, high-frequency applications in the range of 100 kHz may also be implemented.

Finally, it may be advantageous to use the device for heating metallic strips, slabs, bolts, or pipes. Metallic stocks of greatly varying geometries may be heat treated due to the variable geometry of the device and the possibility of opening the coil.

In the following, multiple embodiments of the device according to the present invention are described with reference to twelve figures.

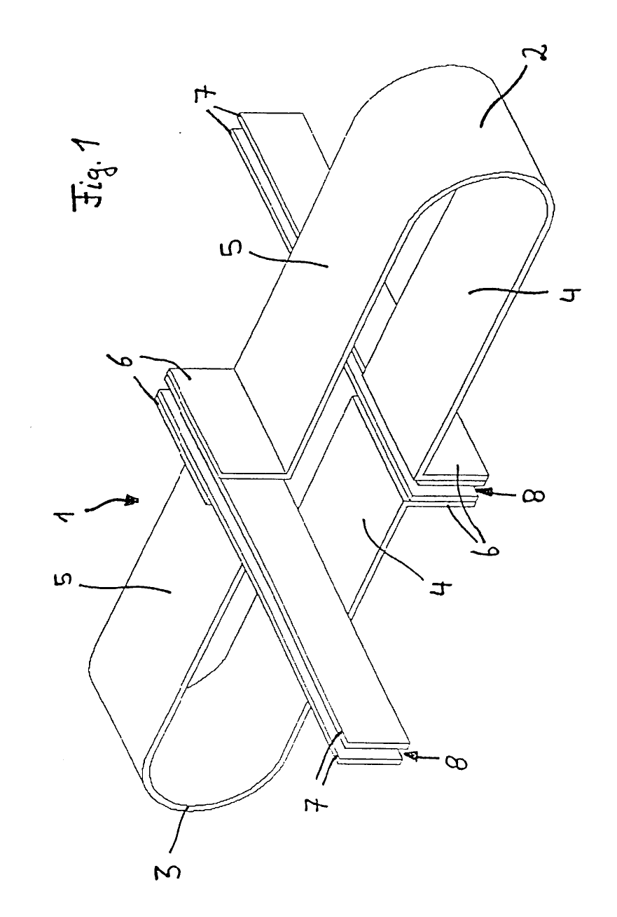

FIG. 1: shows a schematic illustration of a single-turn device for heating metallic strip in the operating position; without stock,

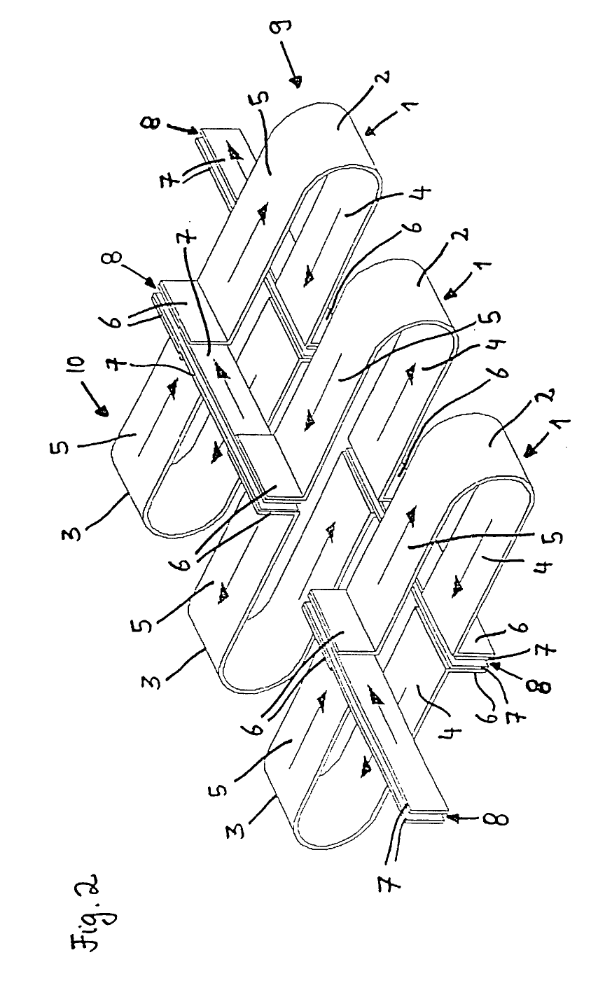

FIG. 2: shows a schematic illustration of a three-turn device for heating metallic strip in the operating position; without stock,

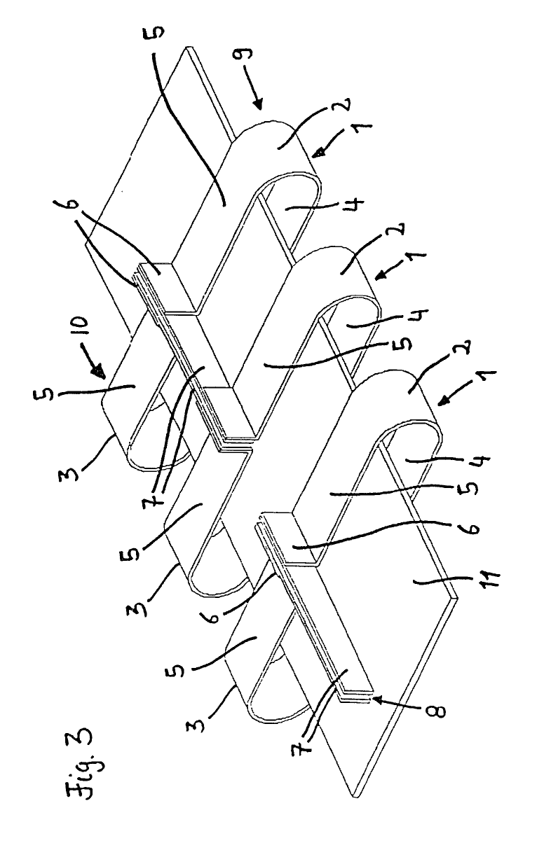

FIG. 3: shows a schematic illustration of the device from FIG. 2 with strip to be heated,

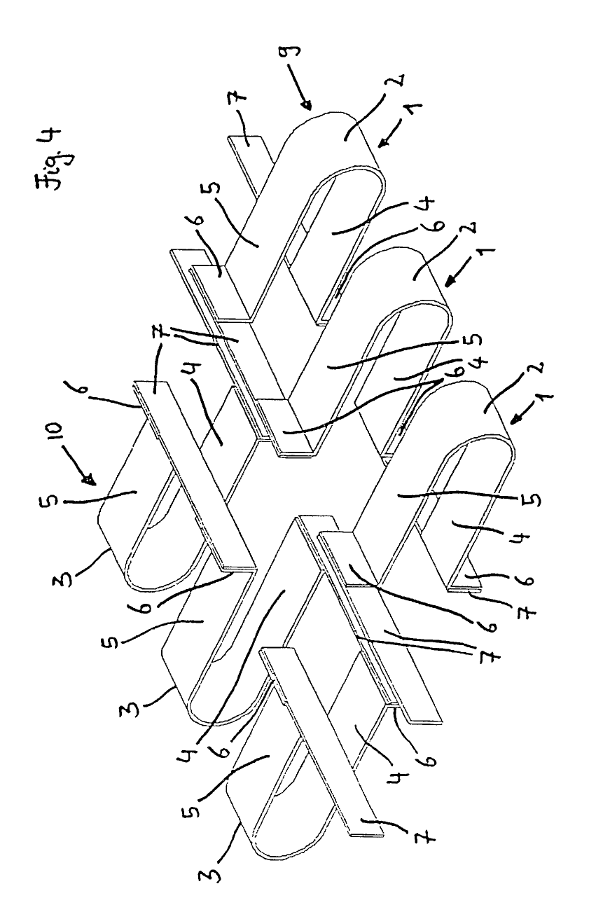

FIG. 4: shows a schematic illustration of the device shown in FIG. 2 in pulled-apart position; without strip,

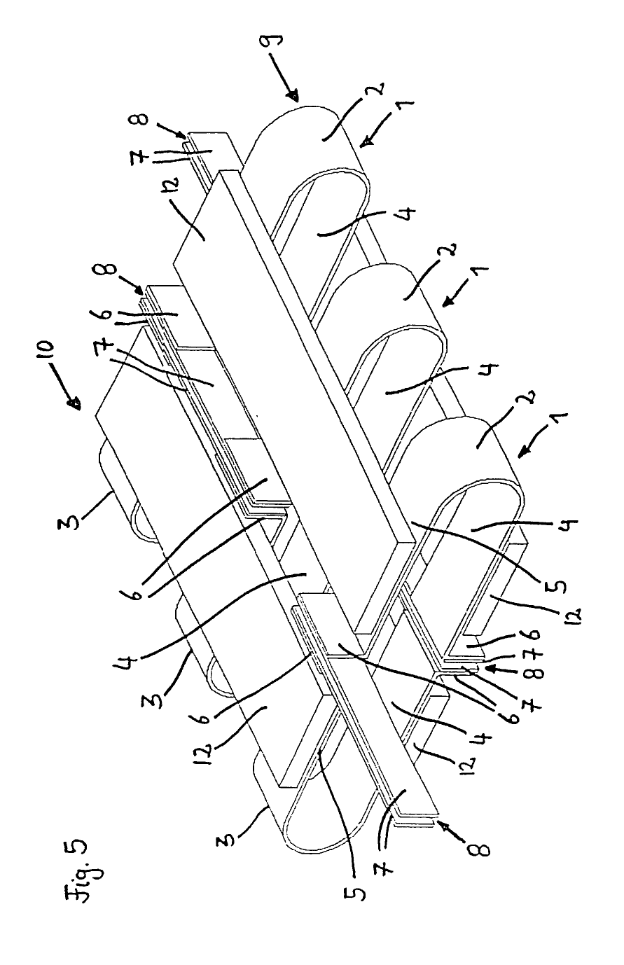

FIG. 5: shows a schematic illustration of the device from FIG. 2 with yokes,

FIG. 6: shows a schematic illustration of the device from FIG. 2 with a protective gas tunnel and strip to be heated,

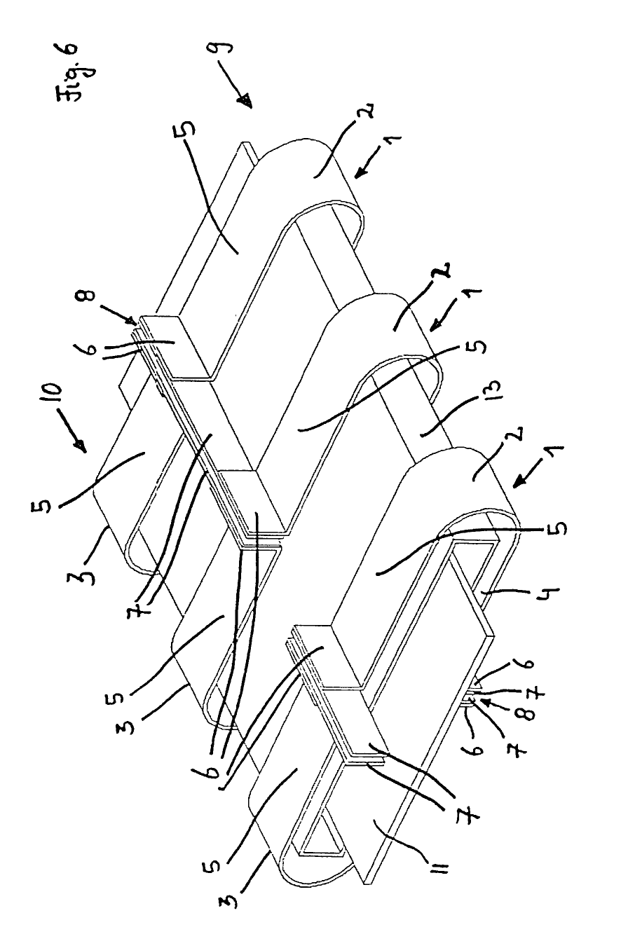

FIG. 7: shows a schematic illustration of a three-turn device for heating metallic pipes or rods; without stock,

FIG. 8: shows a schematic illustration of a three-turn device, whose width may be varied, for heating metallic strips; without stock,

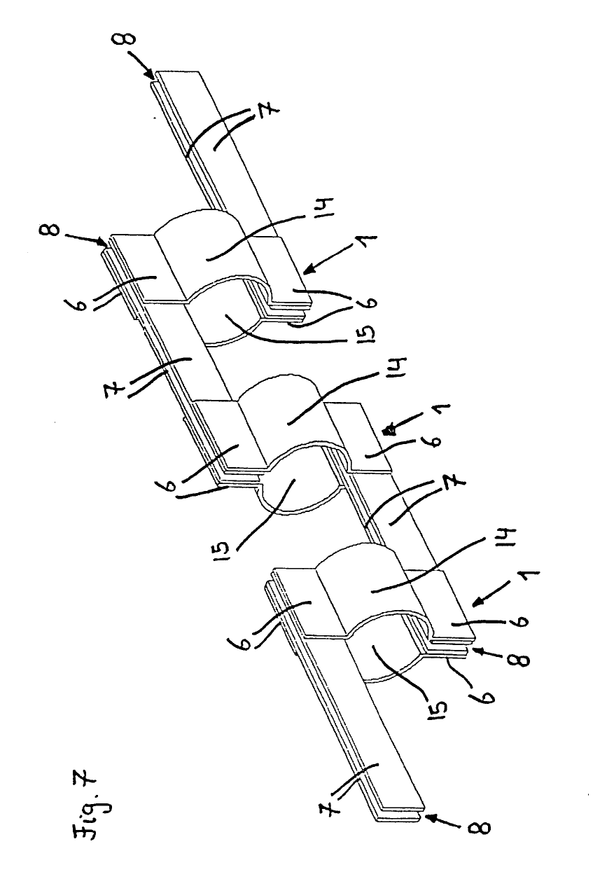

FIG. 9: shows a symbolic illustration of the connection of a coil to an inverter and a compensation module using a solid connection,

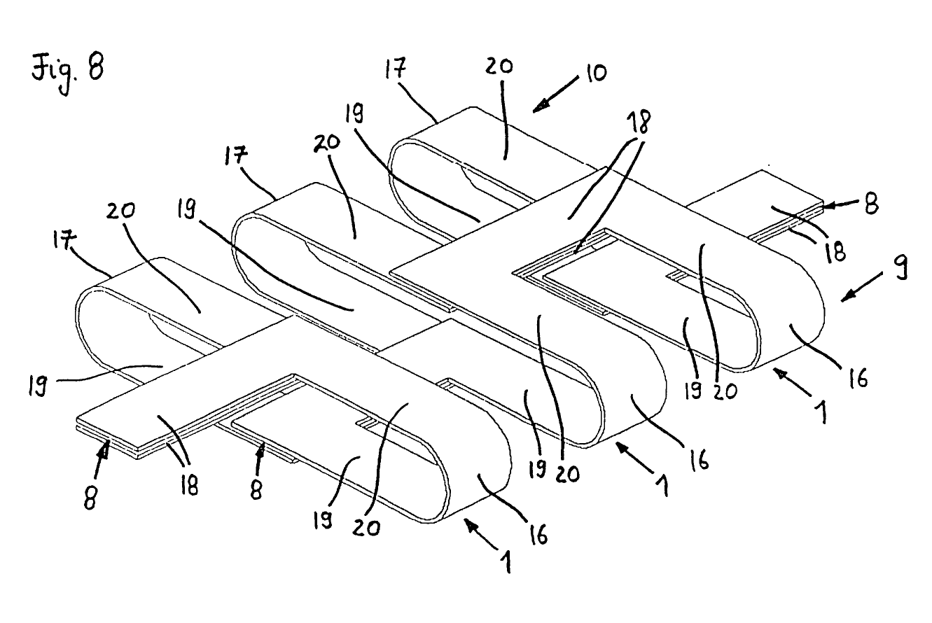

FIG. 10: shows a symbolic illustration of the connection of a coil to an inverter and a compensation module using a flexible connection,

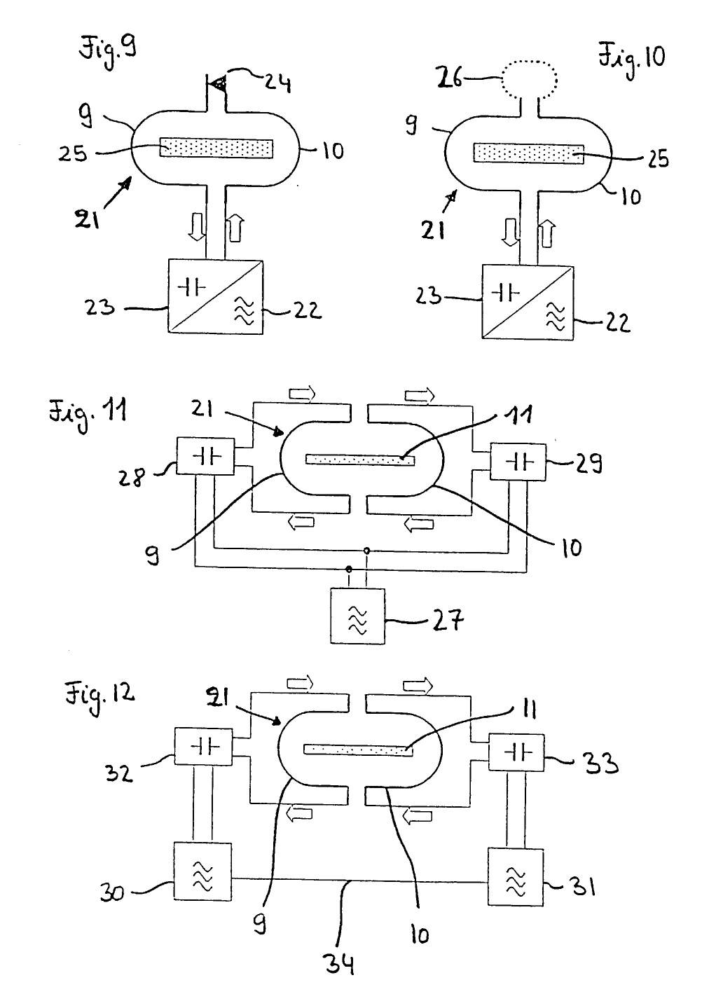

FIG. 11: shows a symbolic illustration of the connection of a coil to an inverter and two compensation modules, and

FIG. 12: shows a symbolic illustration of the connection of a coil to two inverters, each having a compensation module.

In FIG. 1, a device according to the present invention for heating metallic strips in the form of a single-turn coil is schematically illustrated in the operating position. The illustration of the stock was dispensed with for reasons of clarity. Turn 1 includes a first turn half 2 and a second turn half 3, arranged mirror-symmetrically to the first half at a slight distance. However, embodiments and arrangements which are not mirror-symmetric are also conceivable. Each turn half 2, 3 is assembled from a predominantly U-shaped turn half body having two legs 4,5, onto end of each of which a plate-shaped flange 6 is attached perpendicular to the main surface of respective leg 4,5. Each turn half may be divided into one or two neighboring regions in this case.

The width of a flange 6 corresponds to the width of a turn half 2, 3, i.e., the extension of a turn half 2, 3 in the transport direction of the stock. A plate-shaped, electrically conductive connecting element 7, which runs in the transport direction of the stock, engages on each flange 6. Connecting elements 7 arranged in this way form connecting element pairs. Gap 8, illustrated in this figure between connecting elements 7 of each pair and implemented as narrow due to the operating position, is at least partially filled by a solid insulator, not shown here. Plastic plates and/or insulation films are conceivable as solid insulators. First and/or second turn half 2, 3 and respective connecting elements 7 engaging thereon may be implemented in one piece. A two-part coil produced in this way may be pulled apart easily to introduce and remove the stock.

In FIG. 2, a device according to the present invention for heating metallic strips in the form of a three-turn coil is schematically illustrated in operating position. The strip is not illustrated in this case. The device includes two coil halves 9, 10, each having three turn halves 2, 3, arranged one behind the other and connected in series. Each two turn halves 2, 3 facing one another result in one turn 1. One, two, three, or more turns 1 may be provided. Turn halves 2, 3 of a turn 1 are arranged mirror-symmetrically to one another. However, embodiments and arrangements which are not mirror-symmetric are also conceivable. The construction of the individual turn halves corresponds to that from FIG. 1. Turn halves 2 and/or 3, which lie one behind the other in the transport direction of the stock, and respective connecting elements 7 engaging thereon, may be implemented in one piece. Therefore, the device is still only assembled from two main components, which may be disassembled and assembled again using few working steps. This process may be automated very easily.

Individual turn halves 2, 3 are connected to one another in such a way that a connecting element 7, in the form of a connecting plate, which connects flange 6 to nearest flange 6 of a preceding or following turn half 2, 3 in an electrically conductive way, presses against each flange 6. In this case, connecting elements 7 are always arranged in pairs, i.e., if one connecting element 7 connects 1st turn half 2 of a turn 1 to 1st turn half 2 of a preceding turn 1, then mirror-symmetric 2nd turn half 3 is also connected to 2nd turn half 3 of preceding turn 1 via a further connecting element 7. Therefore, alternately, one connecting element pair always runs above and one below the strip to be heated. A narrow gap 8 is provided between opposing connecting elements 7 in the operating position. This gap 8 is at least partially filled with a solid insulator (not shown here), e.g., a plastic plate or insulation films. Therefore, the non-conductive region between connecting elements 7 may be minimized.

This type of the device is also suitable for heating slabs, for this purpose, turn halves 2, 3 must be selected whose legs 4, 5 have a greater distance to one another and therefore ensure a larger coil interior space.

The arrows drawn in the figure show the current path in turns 1 and connecting elements 7. In this case, the currents run in turn halves 2, 3 of a turn 1 like the currents in the turn of an encompassing longitudinal field coil. Since the non-conductive region is minimal and is located over the center of the strip, a region in which the induced current is not subject to a change in direction, a symmetrical and uniform heating appearance arises. This appearance is congruent with the heating appearance of an encompassing longitudinal field coil. The currents in each two connecting elements 7 assigned to one another cancel out and thus do not lead to negative impairment of the longitudinal field.

Multiple variants may be provided for powering the respective coil halves, including turn halves 2, 3 and connecting elements 7. Some of these variants are shown in FIGS. 9 to 12. For example, connecting elements 7 facing one end of the device may be connected to an inverter and the connecting elements on the other end of the device may not be insulated, and an electrical contact may be created by pressing together both connecting elements 7.

FIG. 3 schematically shows the device according to the present invention from FIG. 2, now having strip 11 to be heated in operating position. It is clear that gap 8, which is filled with a solid insulator, not shown here, is located over the center of the strip. The strip edges, which are problematic in heating, lie in the concave curvature of U-shaped turn halves 2, 3 and are subjected there to optimum heating of a homogeneous longitudinal field.

FIG. 4 schematically shows the device according to the present invention from FIGS. 2 and 3 in the pulled-apart state and without strip to be heated. If a strip or slab is to be heated in the device, the heating device, including turn halves 2, 3 and connecting elements 7, is disassembled by being pulled apart into two coil halves 9, 10. In this case, the plastic rails—not shown here—used for insulation may remain on the associated connecting elements of coil halves 2, 3 or be removed. The stock may now be inserted into the coil via the two introduction/removal passages. Subsequently, the coil is closed by being pushed together and the stock is subjected to a heat treatment. After the heat treatment is finished, the coil is pulled apart again and the stock is removed via the introduction/removal passages. In this case, the introduction/removal passages may be opened as wide as desired by being pulled apart.

FIG. 5 schematically shows the device according to the present invention from FIG. 2 in the operating position with four plate-shaped yokes 12 for the magnetic return path. Two yokes 12 are positioned above the heating coil and two yokes 12 are positioned below, arranged on the outsides of legs 4 and 5. In this case, each yoke 12 extends over three turn halves 2, 3. The length of yokes 12 may be tailored to the respective device.

FIG. 6 schematically shows the device according to the present invention from FIG. 2 in the operating position with a protective gas tunnel 13 and strip 11 to be heated. In this case, strip 11 is arranged inside protective gas tunnel 13 and the tunnel is in turn arranged inside the coil. During inductive strip heating, strips are often annealed under a protective gas atmosphere. A protective gas tunnel 13 may easily be introduced into the coil via the wide introduction passages in this case and possibly permanently installed in this position.

In FIG. 7, a device according to the present invention for heating metallic rods and pipes is schematically illustrated. The illustration of a rod or a pipe was dispensed with for reasons of clarity. The construction and the mode of operation essentially correspond to the device from FIG. 2. In this case as well, there are mirror-symmetric turn halves 14, 15, which are coupled to one another in the transport direction via connecting elements 7 in the form of connecting plates. The insulating plastic plates are not shown here. Turn halves 14, 15 are implemented as semicircular and with flanges 6. Due to the shape, which is tailored to the stock, the distance between turns 1 and the stock surface is constant, so that uniform heating may be achieved. Gap 8, which is filled with a solid insulator, only plays a minor role here due to its low width. Non-uniform heating is not to be expected. In addition, pipes or rods may be rotated around their longitudinal axes as they pass through turns 1. In this way, all regions of the stock surface may be subjected to the effects of the non-conductive region—illustrated in the figure as gap 8.

In FIG. 8, a device according to the present invention for heating metallic strips is schematically illustrated in the operating position. The strip is not shown in this figure. In this three-turn device, the width of the longitudinal field space may be varied. In this way, it is possible to treat strips having differing widths using only one device. In this case, U-shaped turn halves 16, 17, which are arranged one behind the other in the transport direction of the stock, and connecting elements 18 of the coil are implemented in one piece. The surfaces of plate-shaped connecting elements 18 engage directly on the ends of legs 19, 20 of turn halves 16, 17 and are aligned parallel to the leg main surfaces. Flanges are not needed in this embodiment. The illustration of the plastic plates between connecting elements 18 was dispensed with. An extremely flat device is possible due to this parallel alignment of connecting elements 18. In the basic position, connecting elements 18, which are arranged parallel to one another, overlap completely. If wider strips are also to be treated, the device may be pulled apart transverse to the transport direction. In this case, connecting elements 18 must still overlap at least slightly.

FIG. 9 shows a symbolic illustration of the connection of one end of each coil half of a two-part coil 21 to a shared inverter 22 and a compensation module 23. The other ends of the coil halves are connected to one another using solid connection 24. The current direction is indicated by arrows. A slab 25 is arranged inside the coil. Solid connection 24 may be, for example, a screw connection or a switch connection. A capacitor battery is provided as compensation module 23. Inverters are illustrated here and in following FIGS. 10 to 12 using a three-wave symbol, since the rated frequency of such a facility may lie in the middle to high frequency range.

FIG. 10 illustrates an alteration of FIG. 9. In this case, solid connection 24 is replaced by a flexible connection 26. For example, a cable may be provided as flexible connection 26. A flexible connection 26 makes it easier to pull coil halves 9, 10 apart and insert the stock.

FIG. 11 shows a symbolic illustration of the connection of coil 21, in which a strip 11 is heated, to an inverter 27 and two compensation modules 28, 29. In this case, both coil halves 9, 10 are each assigned their own compensation module 28 and 29 in the form of capacitors. These capacitors are attached directly to coil 21 and moved together with it when coil 21 is opened. Therefore, the connection between coil 21 and capacitors may be implemented as solid, e.g., in the form of a copper bar or a copper profile. Since the high, uncompensated coil current flows in these connections, better cooling and a design with lower leakage is possible through this construction.

FIG. 12 illustrates an alteration of FIG. 11. FIG. 12 shows a symbolic illustration of the connection of coil 21 to two inverters 30, 31 having compensation modules 32, 33. In this case, right and left coil halves 9, 10 each form their own electric oscillating circuit. Since the current direction in coil 21 must be maintained, it is necessary to synchronize both inverters 30, 31 via a coupling 34.

### List of Reference Numbers

1 turn

2 1st U-shaped turn half

3 2nd U-shaped turn half

4 1st leg

5 2nd leg

6 flange

7 connecting element

8 gap

9 1st coil half

10 2nd coil half

11 strip

12 yoke

13 protective gas tunnel

14 1st semicircular turn half

15 2nd semicircular turn half

16 1st flangeless turn half

17 2nd flangeless turn half

18 connecting element

19 1st leg

20 2nd leg

21 coil

22 inverter

23 compensation module

24 solid connection

25 slab

26 flexible connection

27 inverter

28 1st compensation module

29 2nd compensation module

30 1st inverter

31 2nd inverter

32 1st compensation module

33 2nd compensation module

34 coupling

1. A device for heating metallic stock having a coil (21), which generates a longitudinal field and is to be opened, through which the stock is to be guided, and which is constructed from turn halves (2, 3) and electrically conductive connecting elements (7), both ends of each turn half being arranged opposite one another, each two turn halves (2, 3) forming one complete turn (1), the ends of the turn halves (2, 3) forming a turn standing at a slight distance to one another, each end of a turn half (2, 3) being connected to a connecting element (7) in an electrically conductive way, and the respective connecting elements (7) connected to neighboring ends of two turn halves (2, 3) forming a pair, having current flow through them in opposing directions, and being insulated in relation to one another,
characterized in that the connecting elements (7; 18) of each pair are insulated in relation to one another by at least one solid insulator, and
the turn halves (2, 3; 14, 15; 16, 17) of each turn (1) and the connecting elements (7; 18) of each pair of connecting elements may be pulled apart transverse to the transport direction of the stock to form two introduction passages for metallic stock.

2. The device for heating metallic stock according to claim 1,
characterized in that the coil (21) is constructed from two coil halves (9, 10), each having a turn half (2, 3; 14, 15; 16, 17) and connecting elements (7; 18) connected thereto.

3. The device for heating metallic stock according to claim 1,
characterized in that the coil (21) is constructed from two coil halves (9, 10), each having two or more turn halves (2, 3; 14, 15; 16, 17), which lie one behind the other in the transport direction and are connected to one another in series via the connecting elements (7; 18).

4. The device for heating metallic stock according to one of claims 2 to 3,
characterized in that the coil halves (9, 10) are implemented in one piece.

5. The device for heating metallic stock according to one of claims 1 or 4,
characterized in that the connecting elements (7; 18) are implemented as plate-shaped.

6. The device for heating metallic stock according to claim 5,
characterized in that the main surfaces of the plate-shaped connecting elements (7; 18) are arranged parallel or perpendicular to the longitudinal field of the coil.

7. The device for heating metallic stock according to claim 6,
characterized in that the coil halves (9, 10) are to be arranged transverse to the transport direction with an offset in such a way that the connecting elements (18) of one coil half (9), which are arranged with their main surfaces parallel to the longitudinal field, at least partially overlap with the connecting elements (18) of the other coil half (10), arranged in the same way.

8. The device for heating metallic stock according to one of claims 1 to 7,
characterized in that the connecting elements (7; 18) assigned to one another are insulated in relation to one another by plastic plates.

9. The device for heating metallic stock according to one of claims 1 to 7,
characterized in that the connecting elements (7; 18) assigned to one another are insulated in relation to one another by insulation films.

10. The device for heating metallic stock according to one of claims 1 to 9,
characterized in that the coils (21) are provided with yokes (12).

11. The device for heating metallic stock according to one of claims 1 to 10,
characterized in that a protective gas tunnel, through which the stock is to be guided, is arranged inside the coil (21) in the transport direction of the stock.

12. The device for heating metallic stock according to one of claims 1 to 11,
characterized in that the coils (21) are produced from copper.

13. The device for heating metallic stock according to one of claims 2 to 12,
characterized in that, for supplying power to the coil halves (9, 10), one or two inverters (22; 27; 30, 31) are provided with one individual compensation module, one shared compensation module, or two separate compensation modules (23; 28, 29; 32, 33).

14. The device for heating metallic stock according to one of claims 1 to 12,
characterized in that an inverter (22) is provided on one end of the coil (21) and a flexible connection (26) is provided on the other end.

15. The device for heating metallic stock according to one of claims 1 to 12,
characterized in that an inverter (22) is provided on one end of the coil (21) and two connecting elements (7; 18) are solidly connected on the other end.

16. The device for heating metallic stock according to one of claims 2 to 15,
characterized in that the frequencies and coil currents of both coil halves (9, 10) are identical.

17. The device for heating metallic stock according to one of claims 1 to 16,
characterized in that the frequency is variably adjustable.

18. An application of the device for heating metallic stock according to one of claims 1 to 17,
characterized in that the device is usable for heating metallic strips (11), slabs (25), bolts, or pipes.
